(19) United States
(12) Patent Application Publication
(10) Pub. No.: US 2015/0134584 A1
(43) Pub. Date: May 14, 2015

(54) INFORMATION PROCESSING APPARATUS AND LOAD REDUCTION METHOD

(71) Applicant: FUJITSU LIMITED, Kawasaki-shi (JP)

(72) Inventor: Hiroshi Nakagawa, Kanazawa (JP)

(21) Appl. No.: 14/506,717

(22) Filed: Oct. 6, 2014

(30) Foreign Application Priority Data
Nov. 12, 2013 (JP) 2013-234441

(51) Int. Cl. G06N 5/04

(52) U.S. Cl. CPC G06N 5/04
USPC 706/47

(57) ABSTRACT

A non-transitory computer-readable recording medium stores a load reduction program. The load reduction program causes a computer to execute processing of receiving input of events relating to a rule that is used to provide predetermined information from an input source of an event source, judging whether there is a variation that is predicted to conform to the rule in an input amount per unit time of events that are input within a predetermined period, and changing the input source, when judged that there is no such variation, from an event source of events that are currently being input, to another event source.

### CROSS-REFERENCE TO RELATED APPLICATION(S)

This application is based upon and claims the benefit of priority of the prior Japanese Patent Application No. 2013-234441, filed on Nov. 12, 2013, the entire contents of which are incorporated herein by reference.

### FIELD

The embodiments discussed herein are related to a load reduction program, and the like.

### BACKGROUND

In recent years, complex event processing (CEP) has been known as a technique of processing events that are collected incessantly from various objects. In this complex event processing, a large amount of events are accepted, and events are extracted based on predetermined conditions (rules), and analysis is performed based on the extracted events (Japanese Laid-open Patent Publication Nos. 2002-023823, 2007-287040, 2011-076153).

However, in the conventional technique, there is a problem that a load is applied on the complex event processing. In other words, the amount of events to be accepted has been increasing year after year acceleratedly, and accordingly, there is a load on the complex event processing.

### SUMMARY

According to an aspect of an embodiment, an non-transitory computer-readable recording medium stores therein a load reduction program that causes a computer to execute a process. The process includes receiving input of events relating to a rule that is used to provide predetermined information, from an input source of an event source. The process includes judging whether there is a variation that is predicted to conform to the rule in an input amount per unit time of events that are input within a predetermined period. The process includes changing the input source, when judged that there is no variation, from an event source of events that are currently being input, to another event source.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an entire configuration of a CEP system that includes an information processing apparatus according to a first embodiment;

FIG. 2 indicates one example of a data configuration of a rule table;

FIG. 3 indicates one example of a data configuration of a variation pattern table;

FIG. 4 indicates one example of a data configuration of a mismatch operation table;

FIG. 5 illustrates one example of specific processing of the CEP system according to the first embodiment;

FIG. 6 is a flowchart of load reduction processing according to the first embodiment;

FIG. 7 is a block diagram illustrating an entire configuration of a CEP system that includes an information processing apparatus according to a second embodiment;

FIG. 8 indicates one example of a data configuration of a pattern-match frequency table;

FIG. 9 illustrates one example of specific processing of the CEP system according to the second embodiment;

FIG. 10 is a flowchart of load reduction processing according to the second embodiment;

FIG. 11 is a block diagram illustrating an entire configuration of a CEP system that includes an information processing apparatus according to a third embodiment;

FIG. 12 indicates one example of a data configuration of a variation pattern table;

FIG. 13 illustrates one example of specific processing of the CEP system according to the third embodiment;

FIG. 14A is a flowchart of load reduction processing according to the third embodiment;

FIG. 14B is a flowchart of the load reduction processing according to the third embodiment;

FIG. 15 is a block diagram illustrating an entire configuration of a CEP system that include an information processing apparatus according to a fourth embodiment;

FIG. 16 illustrates one example of specific processing of the CEP system according to the fourth embodiment;

FIG. 17A is a flowchart of load reduction processing according to the fourth embodiment;

FIG. 17B is a flowchart of the load reduction processing according to the fourth embodiment;

FIG. 17C is a flowchart of the load reduction processing according to the fourth embodiment; and

FIG. 18 is a block diagram illustrating one example of a computer that executes the load reduction program.

### DESCRIPTION OF EMBODIMENTS

Preferred embodiments of the present invention will be explained with reference to accompanying drawings. In the following, a case in which the information processing apparatus disclosed in the present application is adopted to a CEP system is explained. Moreover, a case in which the CEP system is used for traffic jam prediction of automobiles is explained. However, the information processing apparatus disclosed in the present application is not limited thereto.

### [a] First Embodiment

### Configuration of CEP System According to First Embodiment

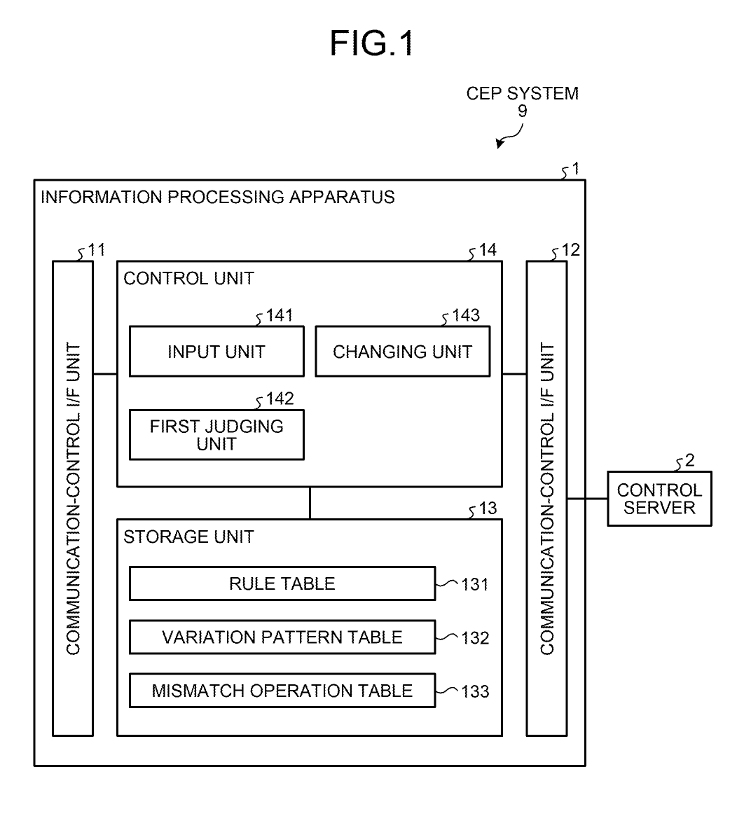

FIG. 1 is a block diagram illustrating an entire configuration of a CEP system that includes an information processing apparatus according to a first embodiment. As illustrated in FIG. 1, a CEP system 9 includes an information processing apparatus 1, and a control server 2. The information processing apparatus 1 is a physical server that performs complex event processing, and is, for example, a data sensor or a server computer that is installed in each company. To the information processing apparatus 1, multiple kinds of events are distributed (input) from event sources that are input sources of the events. There is more than one input source of events. Accordingly, if all events are input from all of the input sources, a large amount of events are to be input to the information processing apparatus 1. Therefore, the information processing apparatus 1 automatically evaluate the variation in the input amount of input events per unit time. Specifically, the information processing apparatus 1 performs filtering (extraction) according to information processing rules used to provide predetermined information, and provides, when extraction succeeds, information in accordance with the rules to the control server 2. The information processing apparatus 1 as described judges whether there is a variation in the input amount per unit time that is expected to conform to the rule. When judged that there is no change in the input amount per unit time that is expected to conform to the rule, the information processing apparatus 1 changes the input source from the event source of the event currently being input to another event source.

The information processing apparatus 1 includes a communication-control interface (I/F) units 11 and 12, a storage unit 13, and a control unit 14. The communication-control I/F units 11 and 12 are interfaces that control communication between networks. The communication-control I/F units 11 receives events that are distributed from various input sources. For example, the communication-control I/F unit 11 receives conditions such as a position and speed of a traveling vehicle distributed from a predetermined area, and information about weather of the area. The predetermined area here is, for example, distinguished in advance by the information processing apparatus 1, and each distinguished area corresponds to each input source. As one example, there is a route A as one input source, and there is a route B as another input source. That is, the communication-control I/F unit 11 receives conditions of a vehicle traveling on the route A as one input source and information about weather, and receives conditions of a vehicle traveling on the route B as one input source. The communication-control I/F unit 12 provides, when extraction succeeds as a result of extracting input events according to the rule, information that conforms to the rule to the control server 2.

The storage unit 13 is a storage device such as a hard disk and an optical disk. The storage unit 13 may be a data rewritable semiconductor memory such as a random access memory (RAM), a read only memory (ROM), a flash memory, and non-volatile static random-access memory (NVSRAM).

The storage unit 13 stores various kinds of information. For example, the storage unit 13 stores an operating system (OS) executed by the control unit 14 and a program to perform various kinds of processing such as input processing, determination processing, and variation processing described later. Furthermore, the storage unit 13 stores various kinds of data that are used to execute a program that is executed by the control unit 14. For example, the storage unit 13 stores a rule table 131, a variation pattern table 132, and a mismatch operation table 133.

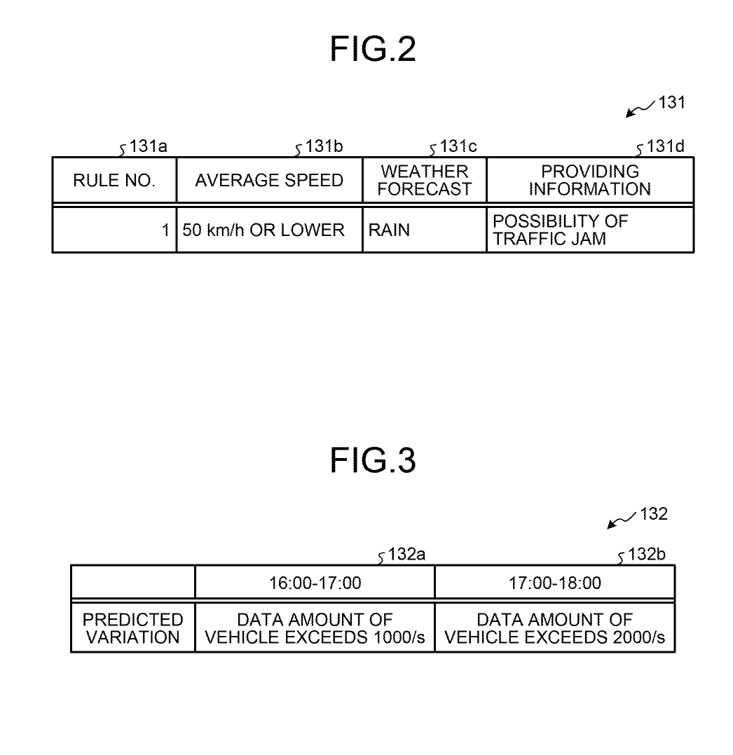

The rule table 131 is a table in which filtering rules are stored. As one example, in the rule table 131, a rule constituted of more than one condition is stored by a user to predict occurrence of a traffic jam of vehicles. One example of a data configuration of the rule table 131 is explained referring to FIG. 2. FIG. 2 indicates one example of a data configuration of a rule table. As indicated in FIG. 2, the rule table 131 stores rule number 131a, average speed 131b, weather forecast 131c, and providing information 131d in an associated manner. The rule number 131a is an identification number to identify a rule uniquely. The average speed 131b indicates a condition relating to an average speed of a vehicle to which the rule is applied. The weather forecast 131c indicates a condition relating to weather of an area in which the vehicle is positioned. The providing information 131d is information that is provided to the control server 2 when conforming to all the conditions. As one example, when the rule number is “1”, “50 kilometers (km)/hour (h) or lower” as the average speed 131b, “rain” as the weather forecast 131c, and “possibility of traffic jam” as the providing information 131d are stored therein.

The variation pattern table 132 stores variation patterns in event input that are expected when conforming to the rule. For example, in the variation pattern table 132, an expected variation pattern of input events when a traffic jam occurs is stored by a user to predict occurrence of a traffic jam of vehicles. As one example, a variation pattern is expressed as that the input amount of events per unit time that are input in a predetermined time period exceeds a threshold, or is within a range of upper and lower thresholds, and the like. Variation patterns can be dynamically changed by a user according to conditions.

The mismatch operation table 133 stores operation performed when a variation pattern does not match. That is, the mismatch operation table 133 stores operation performed when the input amount of events that are input from a specific input source does not match with the variation pattern. As one example, the mismatch operation table 133 is stored by a user in advance. A data configuration of the mismatch operation table 133 is described later.

The control unit 14 includes an internal memory to store a program that regulates various kinds of processing procedures and control data, and performs various kinds of processing thereby. The control unit 14 corresponds to, for example, an electronic circuit of an integrated circuit such as an application specific integrated circuit (ASIC) and a field programmable gate array (FPGA). Moreover, the control unit 14 corresponds to an electronic circuit such as a central processing unit (CPU) and a micro processing unit (MPU). Furthermore, the control unit 14 includes an input unit 141, a first judging unit 142, and a changing unit 143.

The input unit 141 receives input of an event relating to a rule that is used to provide predetermined information, from an input source of an event source. For example, when the rule is used to provide prediction information of occurrence of a traffic jam of vehicles, an input source in which a traffic jam is predicted to occur is set as a default input source. That is, the input unit 141 receives input of an event not from multiple existing input sources but from the specified input source. As one example, an input event has a data configuration in an extensible markup language (HTML) format.

The first judging unit 142 judges whether there is a variation conforming to the rule in the input amount of events per unit time. For example, the first judging unit 142 judges whether the input amount of events per unit time that are input in a predetermined time period matches with the variation pattern of a predated variation stored in the variation pattern table 132. If matching with the variation pattern of the predicted variation even once within a predetermined time period, it is judged as a match with the variation pattern.

A data configuration of the variation pattern table 132 is explained referring to FIG. 3. FIG. 3 indicates one example of a data configuration of the variation pattern table. As indicated in FIG. 3, the variation pattern table 132 stores a predicted variation that is predicted to conform to the rule. In the example of FIG. 3, a variation pattern that has two factors 132a and 132b is set as a predicted variation. In the one factor 132a, “data amount of vehicle exceeds 1000/second (s) from 16:00 to 17:00” is set. In the other factor 132b, “data amount of vehicle exceeds 2000/s from 17:00 to 18:00” is set. That is, the first judging unit 142 judges whether the input amount per second of input events of a vehicle exceeds 1000 from 16:00 to 17:00. In addition, the first judging unit 142 judges whether the input amount per second of input events of a vehicle exceeds 2000 from 17:00 to 18:00.

Referring back to FIG. 1, the changing unit 143 changes the input source from the event source of an event currently being input, to another event source when there is no variation that is expected to conform to the rule in the input amount per unit time. For example, when the first judging unit 142 judges that it does not match with the variation pattern of a predicted variation, the changing unit 143 changes the input source from the event source of events currently being input, to another event source. The input source is changed based on an operation at mismatch 133b stored in the mismatch operation table 133, as one example.

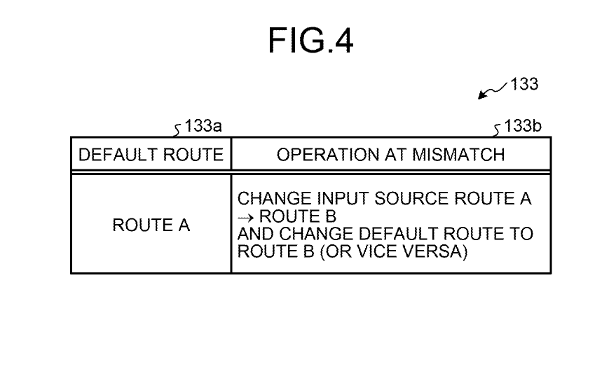

A data configuration of the mismatch operation table 133 is explained, referring to FIG. 4. FIG. 4 indicates one example of a data configuration of the mismatch operation table. As indicated in FIG. 4, the mismatch operation table 133 stores a default route 133a and the operation at mismatch 133b in an associated manner. In the default route 133a, a route of an event source of an input is set. That is, when a rule is used to provide prediction information of occurrence of a traffic jam of vehicles, an input source that is an event source in which a traffic jam is predicted to occur is set as a default route. In the operation at mismatch 133b, operation performed when the input amount of events does not match with a variation pattern is set. That is, in the operation at mismatch 133b, operation performed when the first judging unit 142 judges that the input amount of events per unit time does not match with a variation pattern is set. As one example, when the default route 133a is the “route A”, as the operation at mismatch 133b, it is stored as “change input source from route A to route B”, and “change default route to B (or vice versa)”. Specifically, when events are being input from the input source of the route A, and if the input amount of input events does not match with the variation pattern, the changing unit 143 changes the input source from the route A to the route B, and changes the default route 133a to the route B. On the other hand, when events are being input from the input source of the route B, and if the input amount of input events does not match with the variation pattern, the changing unit 143 changes the input source from the route B to the route A, and changes the default route 133a to the route A.

### One Example of Specific Processing of CEP System

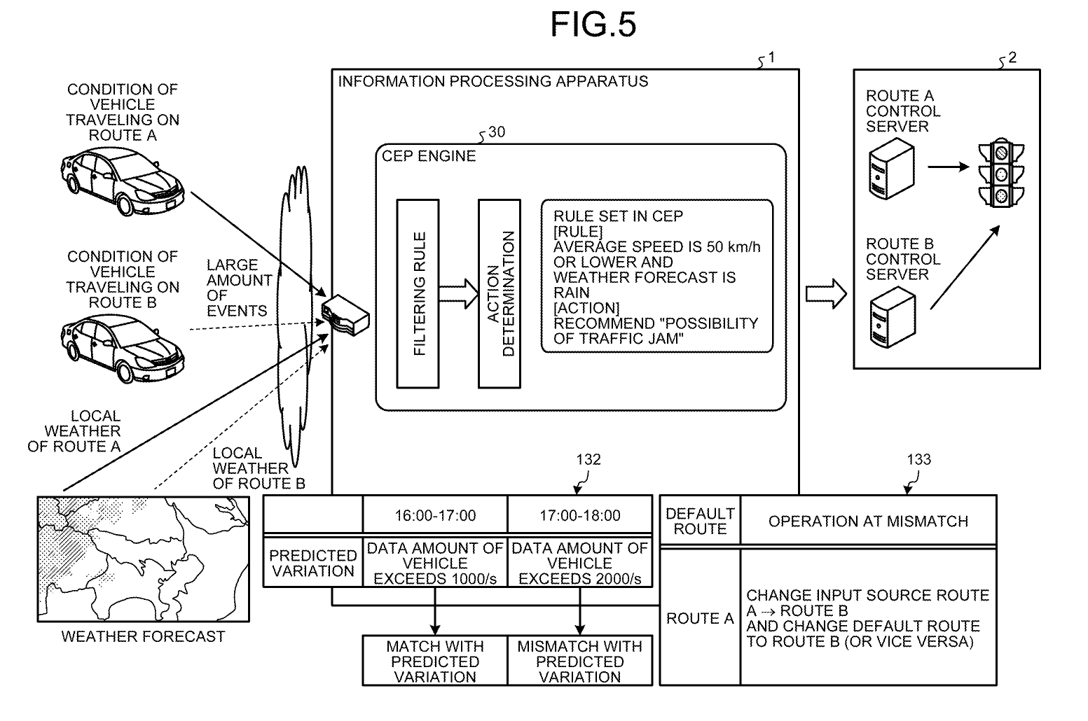

FIG. 5 illustrates one example of specific processing of the CEP system according to the first embodiment. As illustrated in FIG. 5, the information processing apparatus 1 is operated by a CEP engine 30. The CEP engine 30 is included in the control unit 14, and is software that implements a complex event processing. As software that implements a complex event processing, for example, Esper is available.

In the information processing apparatus 1, “average speed is 50 km/h or lower, and weather forecast is rain” is set as a rule that is set by a user in advance. As an action in the case of conforming to this rule, to recommend (provide) “possibility of traffic jam” is set.

Moreover, in the variation pattern table 132, that a “data amount of vehicle exceeds 1000/second from 16:00 to 17:00” is set as a variation pattern of the predicted variation that is expected to conform to the rule. In addition, it is set that a “data amount of vehicle exceeds 2000/second from 17:00 to 18:00”. That is, if matching with this variation pattern, the information processing apparatus 1 predicts that it conforms to the rule that “average speed is 50 km/h, and weather forecast is rain”. When conforming to the rule, the information processing apparatus 1 recommends “possibility of traffic jam” to the control server 2. As a result, the control server 2 can control traffic lights on the route on which a traffic jam is occurring to avoid a traffic jam, for example. On the other hand, when not matching with this variation pattern, the information processing apparatus 1 predicts that it does not conform to the rule, and therefore, changes the current input source to another input source.

In the mismatch operation table 133, the route A is set as the default route 133a, and to change the input source from the route A to the route B is set as the operation at mismatch 133b.

In the information processing apparatus 1 as described, because the current input source that distributes events is the route A, the input unit 141 receives input of an event of a condition of a vehicle from a vehicle that is traveling on the route A, and local weather of the route A from a weather forecast site. On the other hand, in the information processing apparatus 1, the input unit 141 does not receive input of an event of a condition of a vehicle from a vehicle that is traveling on the route B, and local weather of the route B from a weather forecast site.

In the information processing apparatus 1, the first judging unit 142 judges whether the input amount of events per unit time that are input within a predetermined time period matches with a variation pattern of a predicted variation that is stored in the variation pattern table 132. That is, the first judging unit 142 judges whether the input amount per second of events of conditions of a vehicle exceeds 1000/s from 16:00 to 17:00, and exceeds 2000/s from 17:00 to 18:00. In this example, suppose the input amount per second of events of conditions of a vehicle matches with the predicted variation that the input amount exceeds 1000/s from 16:00 to 17:00, but does not match with the predicted variation that the input amount exceeds 2000/s from 17:00 to 18:00.

In the information processing apparatus 1, when judged that it does not match with the variation pattern of the predicted variation, the changing unit 143 changes the input source from the event source of an event that is currently being input, to another event source based on the operation at mismatch 133b that is stored in the mismatch operation table 133. In addition, the changing unit 143 changes the default route 133a. In this example, the input source is changed from the route A to the route B, based on the operation at mismatch 133b stored in the mismatch operation table 133. In addition, the default route 133a is changed to the route B.

When the default route 133a is changed to the route B, the input unit 141 receives input of an event of conditions of a vehicle from a vehicle that is traveling on the route B, and an event of local weather of the route B from a weather forecast site. On the other hand, the input unit 141 does not receive input of an event of conditions of a vehicle from a vehicle that is traveling on the route A, and an event of local weather of the route A from a weather forecast site. Thereafter, the first judging unit 142 judges whether the input amount per unit time of events that are input within a predetermined time period matches with a variation pattern of a predicted variation that is stored in the variation pattern table 132. When judged that it does not match with the variation pattern of a predicted variation, the changing unit 143 changes the input source from the event source of an event currently being input, to another event source, and changes the default route 133a, based on the operation at mismatch 133b stored in the mismatch operation table 133. In this example, the input source is changed from the route B to the route A, and the default route 133a is changed to the route A.

As described, the information processing apparatus 1 uses a variation pattern of a predicted variation that is expected to conform to a rule to change the input source such that an event that is expected to conform to the rule is distributed, and receives input of an event from the input source thus changed. Therefore, the information processing apparatus 1 can avoid input of events from all of the input sources, and reduces a load of the complex event processing.

Procedure of Load Reduction Processing

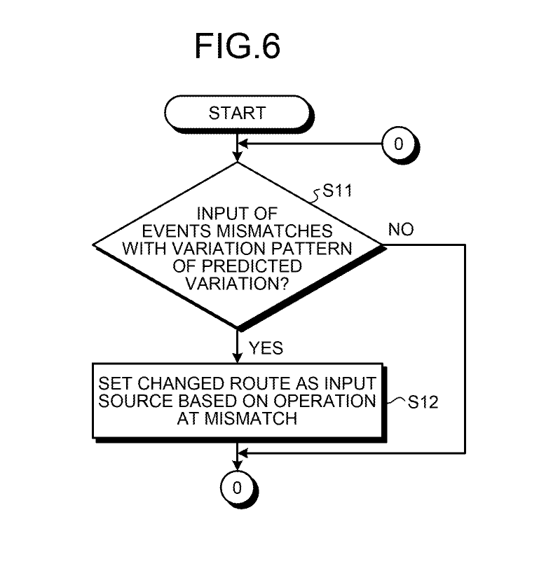

Next, referring to FIG. 6, a procedure of load reduction processing is explained. FIG. 6 is a flowchart of load reduction processing according to the first embodiment. In the mismatch operation table 133, the route A is set as the default route 133a, and to change the input source from the route A to the route B is set as the operation at mismatch 133b. In the variation pattern table 132, a variation pattern is set as a predicted variation. The input unit 141 receives input of events from the input source of the route A that is set as the default route 133a.

First, the input unit 141 receives input of events from the input source of the route A that is set as the default route 133a. The first judging unit 142 then makes judgment about the input of events whether the variation pattern of a predicted variation is mismatched (step S11). For example, the first judging unit 142 judges whether the input amount per unit time of events that are input within a predetermined time period matches with the variation pattern of a predicted variation that is stored in the variation pattern table 132.

When judgment as mismatched with the variation pattern of the predicted variation is made about the input of events (step S11: YES), the changing unit 143 sets the route to be changed as the input source, based on the operation at mismatch 133b (step S12). For example, the changing unit 143 changes the input source from the route A, which is the current default route, to the route B based on the operation at mismatch 133b stored in the mismatch operation table 133. Furthermore, the changing unit 143 sets the route B as the default route 133a. The load reduction processing then shifts to step S11. Thereafter, the input unit 141 receives input of events from the route B that is the input source thus changed.

On the other hand, when judgment as not mismatched with the variation pattern of a predicted variation is made about the input of events (step S11: NO), the changing unit 143 has no processing to perform. The load reduction processing then shifts to step S11. That is, the input unit 141 continues to receive input of events from the route A that is the current input source.

### Effect of First Embodiment

According to the first embodiment described above, the information processing apparatus 1 receives input of events relating to a rule that is used to provide predetermined information from an input source of the event source. The information processing apparatus 1 then judges whether there is a variation that is expected to conform to a rule, in the input amount per second of events that are input within a predetermined time period. The information processing apparatus 1 changes, when judging that there is no variation that is expected to conform to the rule in the input amount per second by the judgment processing, the input source from the event source of events that are currently being input, to another event source. According to such a configuration, when there is no variation that is expected to conform to a rule for events input from the input source, the information processing apparatus 1 changes the input source of events to be input. As a result, the information processing apparatus 1 can avoid input of events from all of the input sources, and can reduce a load of the complex event processing.

Moreover, according to the first embodiment described above, the information processing apparatus 1 judges whether the input amount per second of events that are input within a predetermined time period matches with a predicted variation that indicates to exceed a threshold as a variation. The information processing apparatus 1 changes, when judged as not matched with the predicted variation by the judgment processing, the input source from the event source of events that are currently being input, to another event source. According to such a configuration, the information processing apparatus 1 changes, when not matching with the predicted variation that indicates to exceed a threshold as the variation for the events input from the input source, the input source of events to be input. As a result, the information processing apparatus 1 can avoid input of events from all of the input sources, and can reduce a load of the complex event processing.

### [b] Second Embodiment

In the first embodiment, the information processing apparatus 1 changes the input source from an event source of events that are currently being input, to another event source based on the operation at mismatch 133b set in advance, when there is no change that is expected to conform to a rule in the input amount per second of events. However, the information processing apparatus 1 is not limited thereto. The information processing apparatus 1 may count the number of times of variations of each of the event sources, and may determine, after a predetermined time passes, an event source to which the input source is changed automatically in descending order of the number of times.

Therefore, in a second embodiment, a case in which the number of times of variations of each of event sources within a predetermined time period, and an event source to which the input source is changed is determined automatically in descending order of the number of times to change the input source to the determined event source is explained.

### Configuration of CEP system According to Second Embodiment

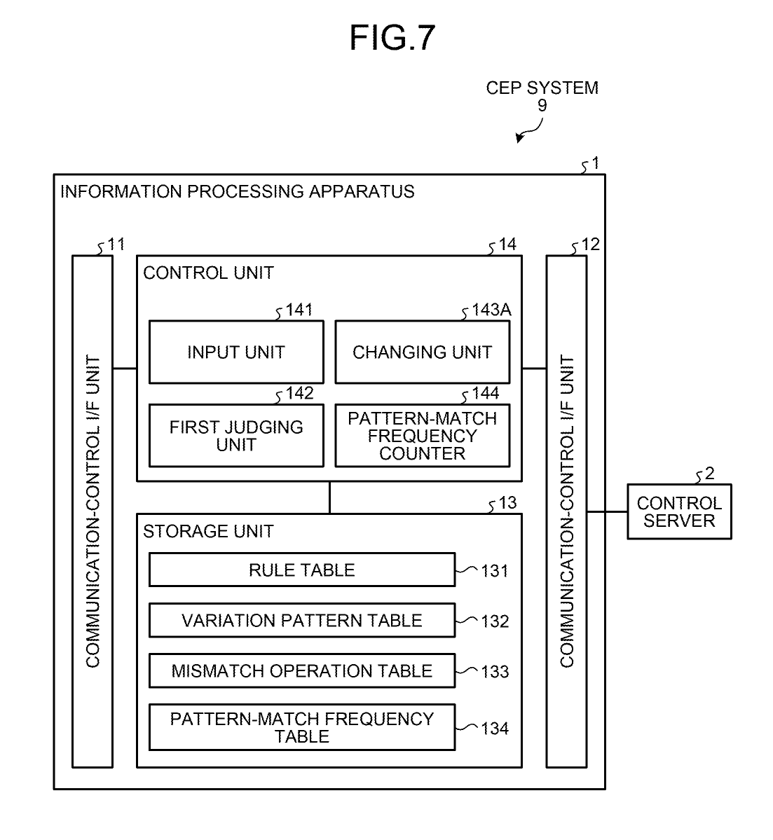

FIG. 7 is a block diagram illustrating an entire configuration of a CEP system that includes an information processing apparatus according to the second embodiment. Like reference numerals are given to like parts in the CEP system 9 illustrated in FIG. 1, and duplicated explanation of a configuration and operation thereof is omitted. The difference between the first embodiment and the second embodiment is that a pattern-match frequency counter 144 is added to the control unit 14. The difference between the first embodiment and the second embodiment is that the changing unit 143 of the control unit 14 is changed to a changing unit 143A. Moreover, the difference between the first embodiment and the second embodiment is that a pattern-match frequency table 134 is added to the storage unit 13.

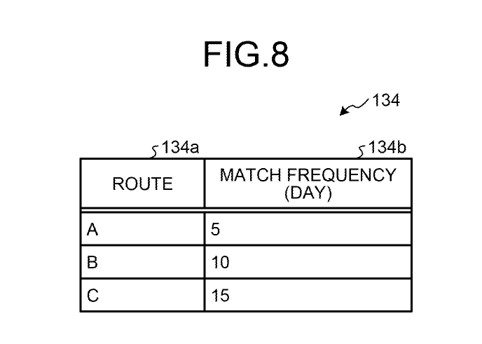

The pattern-match frequency table 134 stores the number of times when a variation pattern is matched for each input source. A data configuration of the pattern-match frequency table 134 is explained referring to FIG. 8. FIG. 8 indicates one example of the pattern-match frequency table. As indicated in FIG. 8, the pattern-match frequency table 134 stores a route 134a and a match frequency (day) 134b in an associated manner. In the route 134a, routes that are all event sources (input sources) are set. In the match frequency (day) 134b, the number of times when a variation pattern is matched is indicated. The match frequency (day) 134b is counted by the pattern-match frequency counter 144 described later, and is counted as once per day when matched. As one example, when the route 134a is “A”, “5” is stored as the match frequency (day) 134b.

The pattern-match frequency counter 144 counts the number of times when there is a change for each of the event sources within a predetermined time period. For example, the pattern-match frequency counter 144 increments the match frequency 134b corresponding to the input source of events currently being input in the pattern-match frequency table 134 by 1 when the first judging unit 142 judges that the variation pattern is matched. The predetermined time period may be a period set by a user in advance, and may be one month, two months, or six months. The match frequency of each event source can be leveled out better if the predetermined time period is set to a comparatively long period.

The changing unit 143A changes, when the first judging unit 142 judges that it does not match with a variation pattern of a predicted, the input source from the event source of events that are currently being input, to another event source based on the operation at mismatch 133b that is stored in the mismatch operation table 133. That is, within the predetermined time period, the changing unit 143A changes the input source from the event source of an event that is currently being input, to another event source based on the operation at mismatch 133b set in advance.

Furthermore, after the predetermined time period passes, the changing unit 143A changes, when the first judging unit 142 judges that it does not match with the variation pattern of the predicted variation, the input source from the event source of events that are currently being input, to another event source based on the counted match frequency 134b. Specifically, the changing unit 143A determines an event source to which the input source is changed automatically in descending order of the match frequency 134b stored in the pattern-match frequency table 134. The changing unit 143A then changes the input source from the event source of events that are currently being input, to the determined event source.

In other words, in the second embodiment, for example, for a route C, it is assumed that although a traffic jam has not occur before the predetermined time, a traffic jam can occur for some reasons. That is, the optimality of a route (input source) that distributes events in the event amount matching with a variation pattern changes with time. Therefore, in the second embodiment, the pattern-match frequency counter 144 counts the number of times of variations of each of the event sources in the predetermined time period. After the predetermined time period passes, the changing unit 143A determines an event source to which the input source is changed automatically in descending order of the number of times, to change the input source to the determined event source.

### One Example of Specific Processing of CEP System

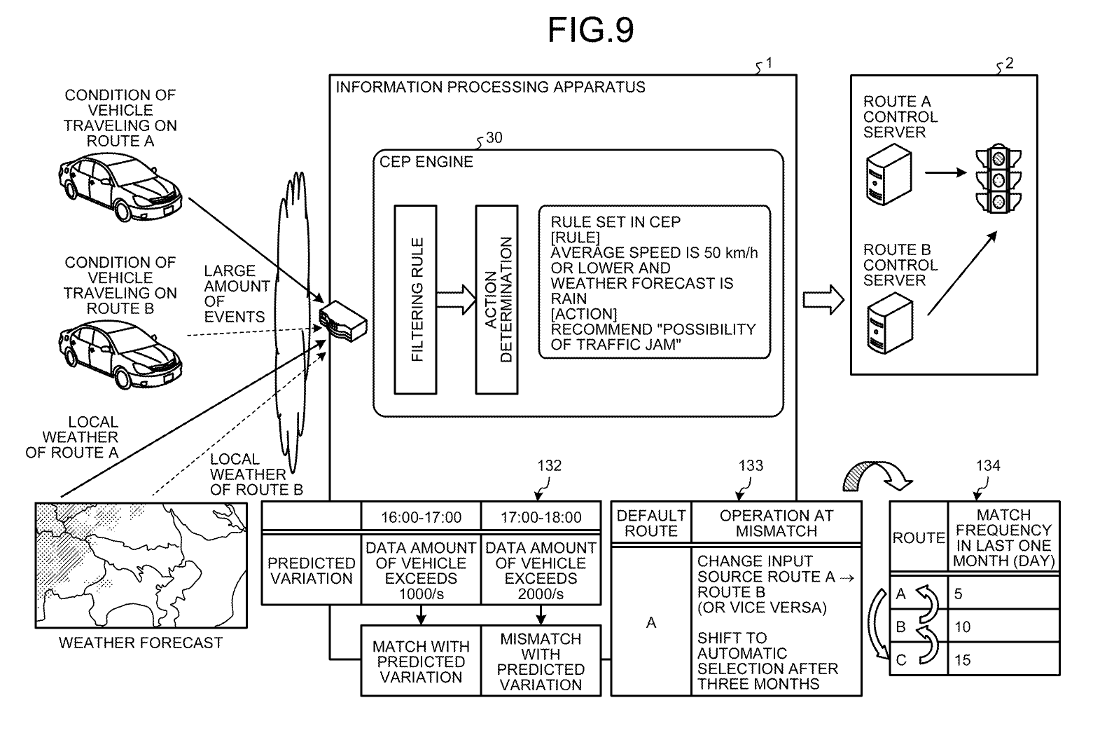

FIG. 9 illustrates one example of specific processing of the CEP system according to the second embodiment. As illustrated in FIG. 9, the CEP engine 30 operates the information processing apparatus 1. The CEP engine 30 is included in the control unit 14, and is software that implements the complex event processing. As software that implements a complex event processing, for example, Esper is available.

In the information processing apparatus 1, “average speed is 50 km/h or lower, and weather forecast is rain” is set as a rule that is set by a user in advance. As an action in the case of matching with this rule, to recommend (provide) “possibility of traffic jam” is set.

Moreover, in the variation pattern table 132, that a “data amount of vehicle exceeds 1000/s from 16:00 to 17:00” is set as a variation pattern of a predicted variation that is expected to conform to the rule. In addition, it is set that a “data amount of vehicle exceeds 2000/s from 17:00 to 18:00”. That is, if the input amount of events per second of vehicles exceeds a predetermined number according to time, the possibility of conforming to the rule that “average speed is 50 km/h or lower, and weather forecast is rain” becomes high. When conforming to the rule, the information processing apparatus 1 recommends “possibility of traffic jam”.

In the mismatch operation table 133, the route A is set as the default route 133a, and to change the input source from the route A to the route B is set as the operation at mismatch 133b. Moreover, to shift to automatic selection from three months later is set as the operation at mismatch 133b. Furthermore, in the pattern-match frequency table 134, the number of times when a variation pattern is matched in last one month is set for each route (input source). Suppose the predetermined time period in which the pattern-match frequency counter 144 counts the match frequency is three months, and suppose one month has already passed.

In the information processing apparatus 1 as described, because the current input source that distributes a current event is the route A, the input unit 141 receives input of an event of a condition of a vehicle from a vehicle that is traveling on the route A, and local weather of the route A from a weather forecast site. On the other hand, in the information processing apparatus 1, the input unit 141 does not receive input of an event of a condition of a vehicle from a vehicle that is traveling on the route B, and local weather of the route B from a weather forecast site.

In the information processing apparatus 1, the first judging unit 142 judges whether the input amount of events per unit time that are input within a predetermined time period matches with a variation pattern of a predicted variation that is stored in the variation pattern table 132. That is, the first judging unit 142 judges whether the input amount per second of events of conditions of a vehicle exceeds 1000/s from 16:00 to 17:00, and exceeds 2000/s from 17:00 to 18:00.

Because it is still within the predetermined time period of three months, the pattern-match frequency counter 144 increments the match frequency 134b corresponding to a route of events that are currently being input in the pattern-match frequency table 134 by 1 when judged that the variation pattern of the predicted variation is matched for each of the routes.

Suppose the input amount per second of events of conditions of a vehicle matches with the predicted variation that the input amount exceeds 1000/s from 16:00 to 17:00, but does not match with the predicted variation that the input amount exceeds 2000/s from 17:00 to 18:00.

Because it is still within the predetermined time period of three months, the changing unit 143A changes, when judged that it does not match with the variation pattern of the predicted variation, the input source from the event source of events that are currently being input, to another event source based on the counted match frequency 134b. In addition, the changing unit 143A changes the default route 133a. In this example, based on the operation at mismatch 133b stored in the mismatch operation table 133, the input source is changed from the route A to the route B. In addition, the default route 133a is changed to the route B.

On the other hand, when three months that is the predetermined time period passes, the changing unit 143A changes, when judged that it does not match with the variation pattern of the predicted variation, the input source from the event source of events that are currently being input, to another event source based on the counted match frequency 134b. In addition, the changing unit 143A changes the default route 133a. Specifically, the changing unit 143A determines an event source to which the input source is changed automatically in descending order of the match frequency 134b stored in the pattern-match frequency table 134. In this example, based on the match frequency 134b stored in the pattern-match frequency table 134, the changing unit 143A changes the input source from the route A to the route C because the match frequency corresponding to the route C has the largest value. In addition, the default route 133a is changed to the route C.

As described, the information processing apparatus 1 uses a variation pattern of a predicted variation that is expected to conform to a rule to count the number of times when the variation pattern is matched in the predetermined time period for each of the input sources. Therefore, the information processing apparatus 1 can maintain the optimality of the input source that distributes events in the event amount that matches with the variation pattern.

Procedure of Load Reduction Processing

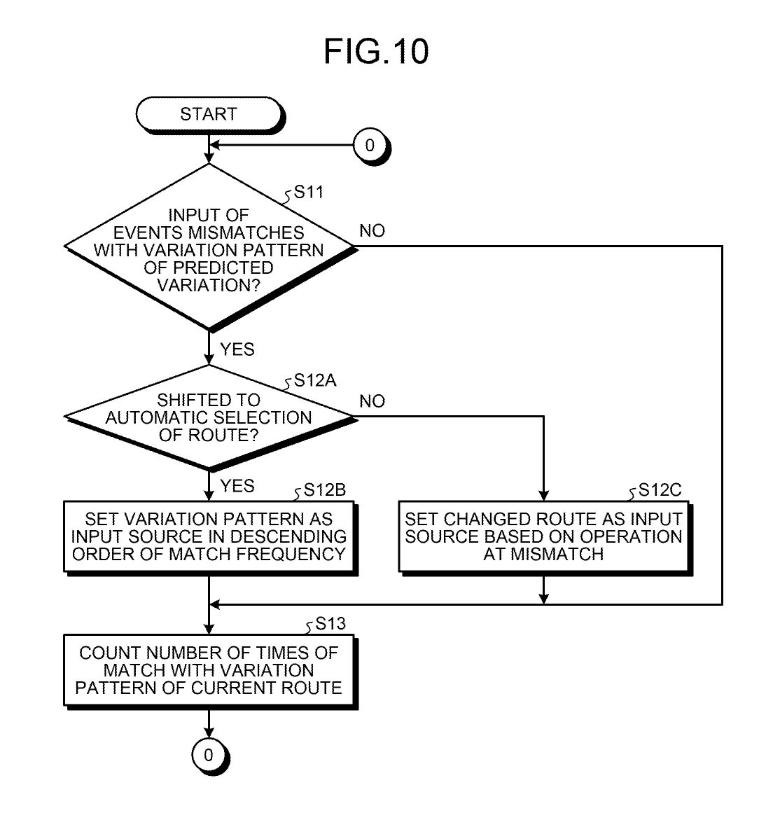

Next, a procedure of load reduction processing is explained referring to FIG. 10. FIG. 10 is a flowchart of load reduction processing according to the second embodiment. In the mismatch operation table 133, the route A is set as the default route 133a, and to change the input source from the route A to the route B is set as the operation at mismatch 133b. In the variation pattern table 132, a variation pattern of a predicted variation is set. The input unit 141 receives input of events from the input source of the route A that is set as the default route 133a. Like reference numerals are given to like processing to that in the load reduction processing indicated in FIG. 6, and duplicated explanation is made brief.

First, the input unit 141 receives input of events from the input source of the route A that is set as the default route 133a. The first judging unit 142 then makes judgment about the input of events whether the variation pattern of a predicted variation is mismatched (step S11).

When judgment as not mismatched with the variation pattern of the predicted variation is made, that is, judged as matched, about the input of events (step S11: NO), the first judging unit 142 shifts to step S13 to count the number of times of match.

On the other hand, when judgment as mismatched with the variation pattern of the predicted variation is made about the input of events (step S11: YES), the changing unit 143 judges whether it has shifted to automatic selection of a route (step S12A). When judged that it has not shifted to the automatic selection (step S12A: NO), the changing unit 143A sets a route to which it is changed as the input source based on the operation at mismatch 133b (step S12C). For example, the changing unit 143 changes the input source from the route A that is the current default route, to the route B based the operation at mismatch 133b stored in the mismatch operation table 133. The changing unit 143A further sets the default route 133a to the route B. The load reduction processing then shifts to step S13. Thereafter, the input unit 141 receives input of events from the route B that is the input source after the change.

On the other hand, when judged that it has shifted to the automatic selection (step S12A: YES), the changing unit 143A sets a route as the input source in descending order of the match frequency of the variation pattern (step S12B). For example, the changing unit 143A determines a route to which the input source is changed in descending order of the match frequency 134b that is stored in the pattern-match frequency table 134. The changing unit 143A then changes the input source from the route A that is the current default route to the determined route. The load reduction processing then shifts to step S13. Thereafter, the input unit 141 receives input of events from the route B that is the input source after the change.

At step S13, the pattern-match frequency counter 144 counts the number of times of match with a variation pattern of the current route (step S13). For example, the pattern-match frequency counter 144 increments the match frequency 134b corresponding to a route of an event that is currently being input in the pattern-match frequency table 134 by 1. The load reduction processing then shifts to step S11.

### Effect of Second Embodiment

According to the second embodiment, the information processing apparatus 1 counts the number of times when there is a variation within a predetermined time period for each of event sources. The information processing apparatus 1 then determines an event source to which it is changed in descending order of the number of times counted by the count processing, from an event source corresponding to a large value to an event source corresponding to a small value. The information processing apparatus 1 then changes the input source to the determined event source from an event source of events that are currently being input. According to such a configuration, the information processing apparatus 1 counts the number of times of match with a variation pattern within a predetermined time period for each of event sources, and can change the input source, by determining an event source in descending order of the number of match, to an optimal event source that changes with time.

### [c] Third Embodiment

In the first embodiment, the information processing apparatus 1 changes the input source from an event source of events that are currently being input, to another event source based on the operation at mismatch 133b set in advance, when the input amount per second of input events does not match with a variation. In the second embodiment, the information processing apparatus 1 counts the number of times of match with a variation pattern of a predicted variation within a predetermined time period for each of event sources. After the predetermined time period passes, the information processing apparatus 1 determines an event source to which it is changed automatically in descending order of the number of times, and changes the input source to the determined event source from an event source of events that are currently being input. However, in a third embodiment, the information processing apparatus 1 is not limited thereto, and may be configured to replace the variation pattern of the predicted variation with another variation pattern even if the input amount does not match with the variation pattern of the predicted variation, but if the input amount matches with the other variation pattern and the number of times of conformity to the rule satisfies a predetermined condition.

Therefore, in the third embodiment, a case in which the information processing apparatus 1 replaces a variation pattern of a predicted variation with another variation pattern when the input amount matches with the other variation pattern and the number of times of conforming to a rule satisfies a predetermined condition, even if the input amount does not match with the variation pattern of a predicted variation is explained.

### Configuration of CEP System According to Third Embodiment

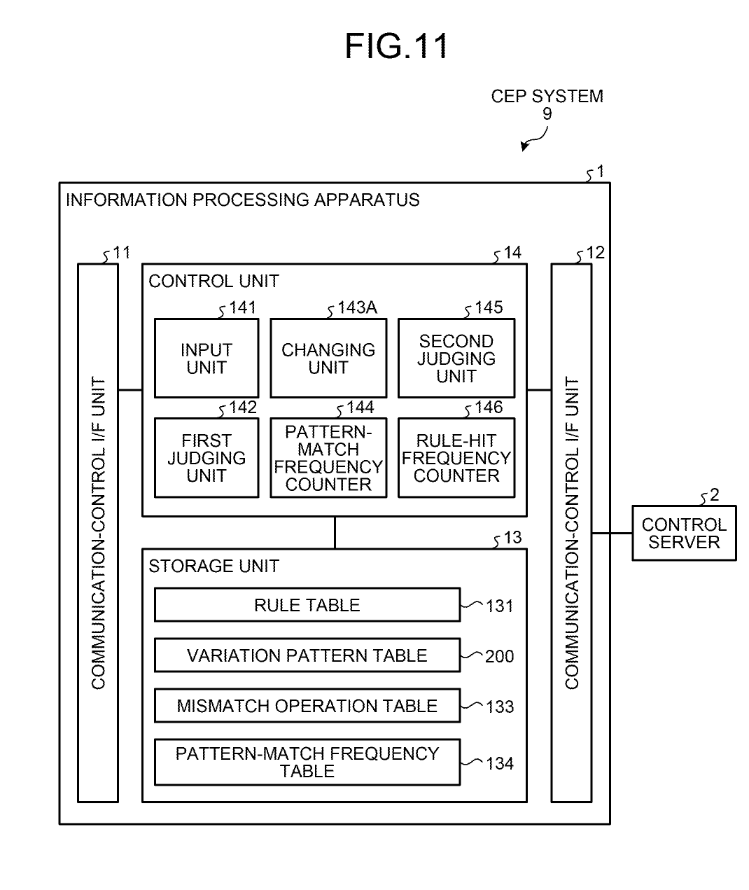

FIG. 11 is a block diagram illustrating an entire configuration of a CEP system that includes an information processing apparatus according to the third embodiment. Like reference numerals are given to like parts in the CEP system 9 illustrated in FIG. 1 and FIG. 7, and duplicated explanation of a configuration and operation thereof is omitted. The difference between the first and the second embodiment and the third embodiment is that a second judging unit 145 and a rule-hit frequency counter 146 is added to the control unit 14. The difference between the first and the second embodiment and the third embodiment is that the variation pattern table 132 is changed to a variation pattern table 200.

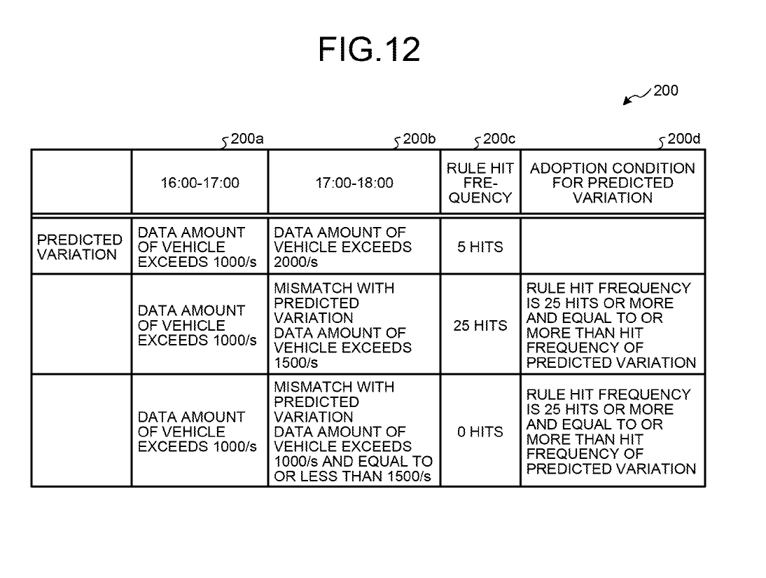

A data configuration of the variation pattern table 200 is explained referring to FIG. 12. FIG. 12 indicates one example of a data configuration of the variation pattern table. AS indicated in FIG. 12, the variation pattern table 200 stores a variation pattern that includes two factors 200a and 200b, a rule hit frequency 200c, and an adoption condition for predicted variation 200d. The one factor 200a of the variation pattern is a condition relating to “16:00 to 17:00”. The other one factor 200b of the variation pattern is a condition relating to “17:00 to 18:00”. Among variation patterns, one variation pattern that is to be a predicted variation that is expected to conform to a rule. The rule hit frequency 200c indicates the number of times of hit to a rule when it is matched with the variation pattern. The adoption condition for predicted variation 200d indicates a condition for adoption to a variation pattern as a predicted variation. That is, when the rule hit frequency 200c corresponding to one variation pattern satisfies the adoption condition for predicted variation 200d, the rule-hit frequency counter 146 adopts the variation pattern as a variation pattern of a predicted variation.

As one example, as a variation pattern of a predicted variation, “data amount of vehicle exceeds 1000/s from 16:00 to 17:00 and “data amount of vehicle exceeds 2000/s from 17:00 to 18:00” are stored. As the rule hit frequency 200c, “5 hits”; and as the adoption condition for predicted variation 200d,”” are stored. Moreover, as another variation pattern, a “data amount of vehicle exceeds 1000/s from 16:00 to 17:00” and “mismatch with predicted variation, amount of data of vehicles exceeds 1500/s from 17:00 to 18:00” are stored. As the rule hit frequency 200c, “25 hits”; and as the adoption condition for predicted variation 200d, “rule hit frequency is 25 hits or more, and equal to rule hit frequency of predicted variation or more” are stored. Furthermore, as another variation pattern, “data amount of vehicle exceeds 1000/second (s) from 16:00 to 17:00” is set. In the other factor 132b, a “data amount of vehicle exceeds 2000/s from 17:00 to 18:00”, and “mismatch with predicted variation, amount of data of vehicles exceeds 1000/s and is 1500/s and less from 17:00 to 18:00” are stored. As the rule hit frequency 200c, “0 hit”; and as the adoption condition for predicted variation 200d, “rule hit frequency is 25 hits or more, and equal to or more than rule hit frequency” are stored.

The first judging unit 142 judges whether the input amount per second of events that are input within a predetermined time period matches with the variation pattern of a predicted variation stored in the variation pattern table 200. When it is matched with the variation pattern even once, it is judged as matched with the variation pattern.

The second judging unit 145 performs the following processing when it is judged that the input amount per second of events that are input within a predetermined time period does not match with the variation pattern of a predicted variation stored in the variation pattern table 200. The second judging unit 145 judges whether the input amount matches with a variation pattern different from the predicted variation stored in the variation pattern table 200. When it is matched with the variation pattern different from the predicted variation even once, it is judged as matched with the variation pattern.

The rule-hit frequency counter 146 performs the following processing when it is judged that the input amount per second of events that are input within a predetermined time period matches with the variation pattern. When any of input events conforms to the rule, the rule-hit frequency counter 146 increments the frequency corresponding to the matched variation pattern by 1. For example, the rule-hit frequency counter 146 judges whether any of the input events conforms to the rule stored in the rule table 131. When it is judged that any of the input events conforms to the rule stored in the rule table 131, the rule-hit frequency counter 146 increments the rule hit frequency 200c corresponding to the matched variation pattern in the variation pattern table 200 by 1.

Moreover, when the rule hit frequency corresponding to the matched variation pattern satisfies a predetermined condition, the rule-hit frequency counter 146 replaces the variation pattern of the predicted variation with the matched variation pattern. For example, the rule-hit frequency counter 146 performs the following processing based on the rule hit frequency 200c corresponding to the matched variation pattern and the adoption condition for predicted variation 200d that are stored in the variation pattern table 200. The rule-hit frequency counter 146 judges whether the rule hit frequency 200c satisfies the adoption condition for predicted variation 200d. When it is judged that the rule hit frequency 200c satisfies the adoption condition for predicted variation 200d, the rule-hit frequency counter 146 replaces the variation pattern of the predicted variation with the matched variation pattern. Specifically, when the input amount of events does not match with the variation pattern of the predicted variation but matches with another variation pattern and if the rule hit frequency corresponding to the other variation pattern is sufficiently high, the rule-hit frequency counter 146 raises the other variation pattern to a variation pattern of the predicted variation.

### One Example of Specific Processing of CEP System

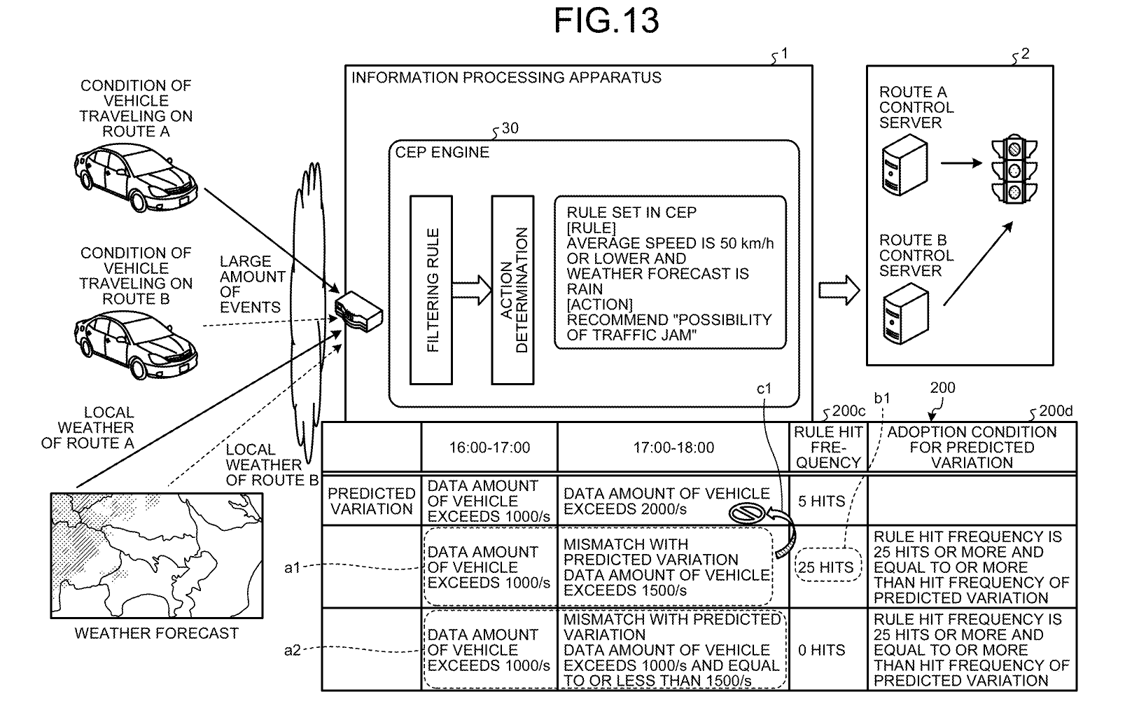

FIG. 13 illustrates one example of specific processing of the CEP system according to the third embodiment. As illustrated in FIG. 13, the information processing apparatus 1 is operated by the CEP engine 30. The CEP engine 30 is included in the control unit 14, and is software that implements a complex event processing. As software that implements a complex event processing, for example, Esper is available.

In the information processing apparatus 1, “average speed is 50 km/h or lower, and weather forecast is rain” is set as a rule that is set by a user in advance. As an action in the case of conforming to this rule, to recommend (provide) “possibility of traffic jam” is set.

Moreover, in the variation pattern table 200, that “data amount of vehicle exceeds 1000/s” from 16:00 to 17:00 is set as a variation pattern of a predicted variation that is expected to conform to the rule. In addition, it is set that “data amount of vehicle exceeds 2000/s” from 17:00 to 18:00. Moreover, as another variation pattern, the same content as the predicted variation is set for 16:00 to 17:00 and “mismatch with predicted variation, amount of data of vehicles exceeds 1500/s” is set for 17:00 to 18:00. Furthermore, as another variation pattern, the same content as the predicted variation is set for 16:00 to 17:00, and “mismatch with predicted variation, amount of data of vehicles exceeds 1000/s and is 1500/s and less” is set for 17:00 to 18:00.

In the information processing apparatus 1 as described, when the current input source that distributes events is the route A, the input unit 141 receives input of an event of a condition of a vehicle from a vehicle that is traveling on the route A, and local weather of the route A from a weather forecast site. On the other hand, in the information processing apparatus 1, the input unit 141 does not receive input of an event of a condition of a vehicle from a vehicle that is traveling on the route B, and local weather of the route B from a weather forecast site.

In the information processing apparatus 1, the first judging unit 142 judges whether the input amount of events per unit time that are input within a predetermined time period matches with the variation pattern of the predicted variation that is stored in the variation pattern table 200. That is, the first judging unit 142 judges whether the input amount per second of events of conditions of a vehicle exceeds 1000/s from 16:00 to 17:00, and exceeds 2000/s from 17:00 to 18:00.

The second judging unit 145 performs the following processing when it is determined that the input amount per second of events that are input within a predetermined time period does not match with the variation pattern of the predicted variation. The second judging unit 145 judges whether the input amount matches with other variation patterns a1 and a2 stored in the variation pattern table 200. In this example, the second judging unit 145 judges that it is matched with the variation pattern a1. Specifically, the second judging unit 145 judges that the input amount of events of conditions of a vehicle exceeds 1000/s from 16:00 to 17:00, and exceeds 1500/s from 17:00 to 18:00.

Subsequently, the rule-hit frequency counter 146 judges whether any of input events that are input from the route A conforms to a rule, and increments, when determining to be conforming thereto, the rule hit frequency 200c corresponding to the matched variation pattern in the variation pattern table 200 by 1. In this example, the rule hit frequency 200c corresponding to the matched variation pattern a1 is incremented by 1, and 25 hits (b1) is set.

The rule-hit frequency counter 146 then judges whether the rule hit frequency 200c corresponding to the matched variation pattern a1 satisfies the adoption condition for predicted variation 200d, and replaces the variation pattern of the predicted variation with the matched variation pattern when determining that the rule hit frequency 200c satisfies the adoption condition for predicted variation 200d. In this example, the rule hit frequency 200c corresponding to the variation pattern a1 is “25 hits”, and the adoption condition for predicted variation 200d is “rule hit frequency is 25 hits or more, and is equal to or more than the rule hit frequency of a predicted variation”. Accordingly, the rule hit frequency 200c corresponding to the variation pattern a1 satisfies the condition of 25 hits or more. Moreover, because the rule hit frequency 200c of the predicted variation is “25 hits”, the rule hit frequency 200c corresponding to the variation pattern a1 satisfies the condition of equal to or more than the rule hit frequency of the predicted variation. The rule-hit frequency counter 146 replaces the variation pattern of the predicted variation with the matched variation pattern a1 (c1).

As described above, even when the variation pattern of the predicted variation is not matched, if another variation pattern is matched and the number of times of conformity to a rule satisfies a condition, the information processing apparatus 1 replaces the predicted variation with the other variation pattern. Therefore, the information processing apparatus 1 can change predicted variations that are expected to conform to a rule dynamically.

Procedure of Load Reduction Processing

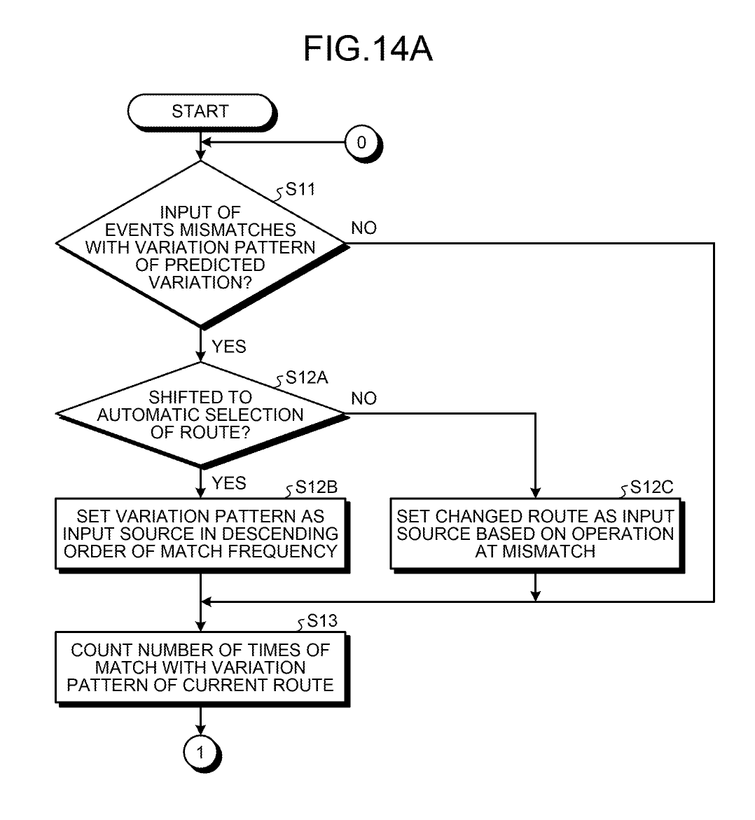

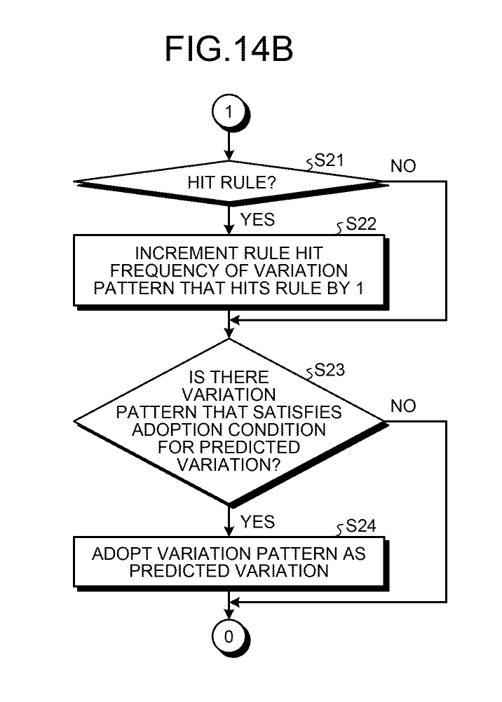

Next, a procedure of load reduction processing is explained referring to FIGS. 14A and 14B. FIG. 14 is a flowchart of the load reduction processing according to the third embodiment. In the mismatch operation table 133, the route A is set as the default route 133a, and to change the input source from the route A to the route B is set as the operation at mismatch 133b. In the variation pattern table 200, a variation pattern of a predicted variation is set. Furthermore, in the variation pattern table 200, another variation pattern is set, and the adoption condition for predicted variation 200d is set as “rule hit frequency is 25 hits or more, and is equal to or more than the rule hit frequency of a predicted variation”. The input unit 141 receives input of an event from the input source of the route A, which is set as the default route 133a. Like reference numerals are given to like processing to that in the load reduction processing indicated in FIG. 10, and explanation of the duplicated processing is made brief.

First, the input unit 141 receives input of events from the input source of the route A that is set as the default route 133a. The first judging unit 142 then makes judgment about the input of events whether the variation pattern of a predicted variation is mismatched (step S11).

When judgment as not mismatched with the variation pattern of the predicted variation is made, that is, judged as matched (step S11: NO), the first judging unit 142 shifts to step S13 to count the number of times of match.

On the other hand, when judgment as mismatched with the variation pattern of a predicted variation is made about the input of events (step S11: YES), the changing unit 143A judges whether it has shifted to automatic selection of a route (step S12A). When judged that it has not shifted to the automatic selection (step S12A: NO), the changing unit 143A sets a route to which it is changed, to the input source based on the operation at mismatch 133b (step S12C). The load reduction processing then shifts to step S13. Thereafter, the input unit 141 receives input of events from the route B that is the input source after the change.

On the other hand, when judged that it has shifted to the automatic selection (step S12A: YES), the changing unit 143A sets a route as the input source in descending order of the match frequency of the variation pattern (step S12B). The changing unit 143A then changes the input source from the route A that is the current default route to the determined route. The load reduction processing then shifts to step S13. Thereafter, the input unit 141 receives input of events from the route B that is the input source after the change.

At step S13, the pattern-match frequency counter 144 counts the number of times of match with a variation pattern of the current route (step S13).

Subsequently, the rule-hit frequency counter 146 judges whether it matches with (hits) the rule (step S21). When judged that the rule is hit (step S21: YES), the rule-hit frequency counter 146 increments the rule hit frequency 200c of the variation pattern that hits the rule by 1 (step S22). For example, the rule-hit frequency counter 146 judges whether any of input events hits the rule stored in the rule table 131. When judging that any of the input events hits the rule stored in the rule table 131, the rule-hit frequency counter 146 increments the rule hit frequency 200c corresponding to the matched variation pattern in the variation pattern table 200 by 1. The rule-hit frequency counter 146 then shifts to step S23.

On the other hand, when judging that the rule is not hit (step S21: NO), the rule-hit frequency counter 146 shifts to step S23.

The rule-hit frequency counter 146 then judges whether there is a variation pattern that satisfies the adoption condition for predicted variation 200d (step S23). When judging that there is a variation pattern that satisfies the adoption condition for predicted variation 200d (step S23: YES), the rule-hit frequency counter 146 adopts the variation pattern as the predicted variation (step S24). Thereafter, the load reduction processing shifts to step S11.

When judging that there is no variation pattern that satisfies the adoption condition for predicted variation 200d (step S23: NO), the rule-hit frequency counter 146 has no processing to perform. The load reduction processing then shifts to step S11.

### Effect of Third Embodiment

According to the third embodiment, when it is judged that variation pattern of the predicted variation is not matched, the information processing apparatus 1 judges whether it matches with another variation pattern in which a threshold of the variation pattern is changed. When judging that it matches with other variation pattern, the information processing apparatus 1 increments the rule hit frequency corresponding to the other variation pattern by 1 if it conforms to the rule. The information processing apparatus 1 replaces the variation pattern of the predicted variation with the other variation pattern when the rule hit frequency satisfies a predetermined condition. According to such a configuration, even when it does not match with the variation pattern of the predicted variation, if it matches with another variation pattern and the number of times of conformity to the rule satisfies a condition, the information processing apparatus 1 replaces the predicted variation with the other variation pattern. Therefore, the information processing apparatus 1 can change predicted variations that are expected to conform to a rule dynamically.

### [d] Fourth Embodiment

In the first embodiment, the information processing apparatus 1 changes the input source from the event source of events that are currently being input, to another event source when the input amount per second of input events does not match with a variation pattern of a predicted variation, based on the operation at mismatch 133b set in advance. In the second embodiment, the information processing apparatus 1 counts, for each of event sources, the number of times when it matches with a variation pattern of a predicted variation in a predetermined time period. The information processing apparatus 1 determines, after the predetermined time passes, an event source to which it is changed automatically in descending order of the number of times, and changes the input source to the determined event source from the event source of events that are currently being input. In the third embodiment, the information processing apparatus 1 replaces a variation pattern of a predicted variation with another variation pattern even when the input amount does not match with the variation pattern of a predicted variation, but if the input amount matches with the other variation pattern and the number of times of conformity to a rule satisfies a predetermined condition. However, the information processing apparatus 1 is not limited thereto, and may be configured to inhibit input of events that is not related to conformity to a rule.

In the fourth embodiment, a case in which the information processing apparatus 1 inhibits input of events that is not related to conformity to a rule is explained.

### Configuration of CEP System According to Fourth Embodiment

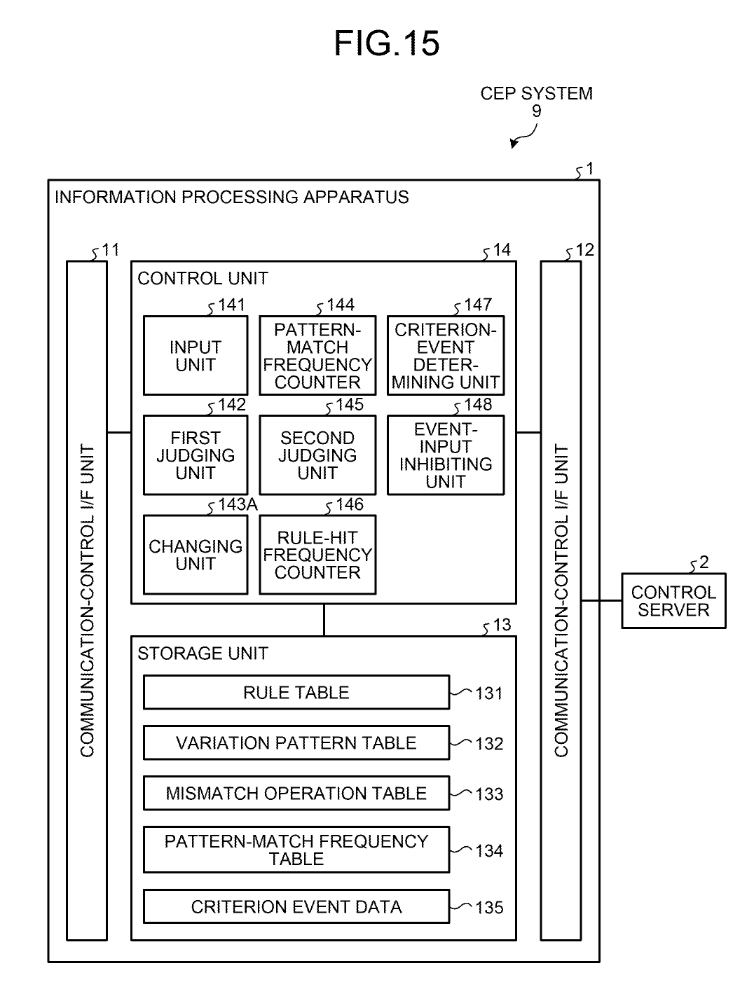

FIG. 15 is a block diagram illustrating an entire configuration of a CEP system that include an information processing apparatus according to a fourth embodiment. Like reference numerals are given to like parts in the CEP system 9 illustrated in FIG. 1, FIG. 7, and FIG. 11, and duplicated explanation of a configuration and operation thereof is omitted. The difference between the first to the third embodiments and the fourth embodiment is that a criterion-event determining unit 147 and an event-input inhibiting unit 148 are added to the control unit 14. The difference between the first to the third embodiments and the fourth embodiment is that a criterion event data 135 is added to the storage unit 13.

The criterion event data 135 is data of an event to be a criterion (referred to as “criterion event”) that is used to determine whether to inhibit input of an event. For example, an event information source the input amount of which is small is determined as the criterion event. For example, when there are a condition of a vehicle and weather forecast as information sources of events, the information source of weather forecast the input amount of events of which is small is determined as a criterion event. The criterion event may be automatically determined by the criterion-event determining unit 147, or may be determined by a user in advance.

The input unit 141 receives input of events relating to a rule that is used to provide predetermined information, from event sources.

The criterion-event determining unit 147 determines a criterion event to an event information source the input amount of which is the smallest when the criterion event is determined automatically. For example, the criterion-event determining unit 147 receives input of events from various kinds of information sources for a predetermined period, and calculates the input amount of each event. Thus, the criterion-event determining unit 147 determines a criterion event to an event information source the input amount of which is the smallest. As one example, suppose the input amount of events from an information source of weather forecast is 1/s, and the input amount of events from an information source of a vehicle is 1500/s. Because the input amount of weather forecast is smaller than the input amount of a vehicle, the criterion-event determining unit 147 determines the criterion event to the information source of weather forecast.

The event-input inhibiting unit 148 inhibits, when contents of the criterion event does not conform to a rule, input of other events. For example, the event-input inhibiting unit 148 judges whether the criterion event among input events unhits the rule. When determining that the criterion event among input events unhits the rule, the event-input inhibiting unit 148 inhibits input of other events that are different from the criterion event.

### One Example of Specific Processing of CEP System

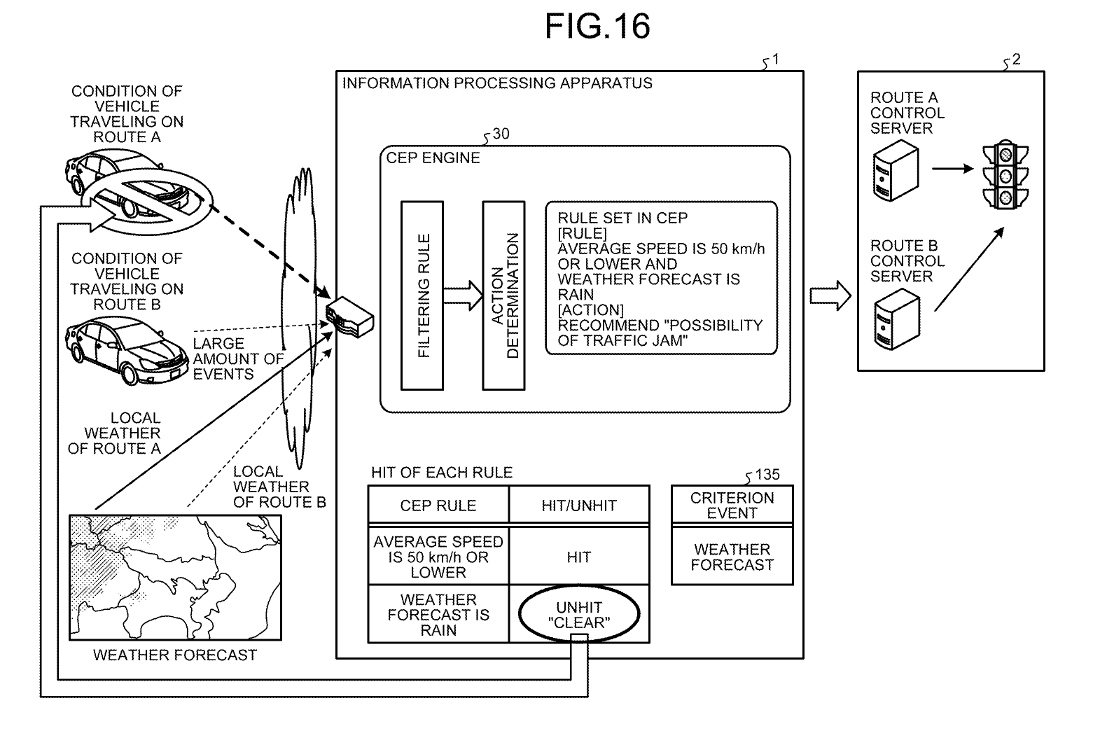

FIG. 16 illustrates one example of specific processing of the CEP system according to the fourth embodiment. As illustrated in FIG. 16, the information processing apparatus 1 is operated by the CEP engine 30. The CEP engine 30 is included in the control unit 14, and is software that implements a complex event processing. As software that implements a complex event processing, for example, Esper is available.

In the information processing apparatus 1, “average speed is 50 km/h or lower, and weather forecast is rain” is set as a rule that is set by a user in advance. As an action in the case of matching with this rule, to recommend (provide) “possibility of traffic jam” is set.

Moreover, in the criterion event data 135, “weather forecast” is set as the criterion event.

In the information processing apparatus 1 as described, when the current input source that distributes events is the route A, the input unit 141 receives input of an event of a condition of a vehicle (information source) from a vehicle that is traveling on the route A, and an event of local weather of the route A from an information source of weather. On the other hand, in the information processing apparatus 1, the input unit 141 does not receive input of an event of a condition of a vehicle from a vehicle that is traveling on the route B, and local weather of the route B.

The event-input inhibiting unit 148 judges whether the criterion event among input events unhits the rule. Suppose weather forecast, which is the input criterion event, indicates “clear” in this example. The event-input inhibiting unit 148 then judges as unhit because it does not hit “weather forecast is rain” that is a part of the rule.

When determining that the criterion event unhits the rule, the event-input inhibiting unit 148 inhibits input of other events that are different from the criterion event. In this example, the event-input inhibiting unit 148 inhibits input of events of conditions of a vehicle.

Thus, the information processing apparatus 1 inhibits input of events at a point when it is found that there is an event that does not conform to the rule, and therefore, a load of a complex event processing can be further reduced.

Procedure of Load Reduction Processing

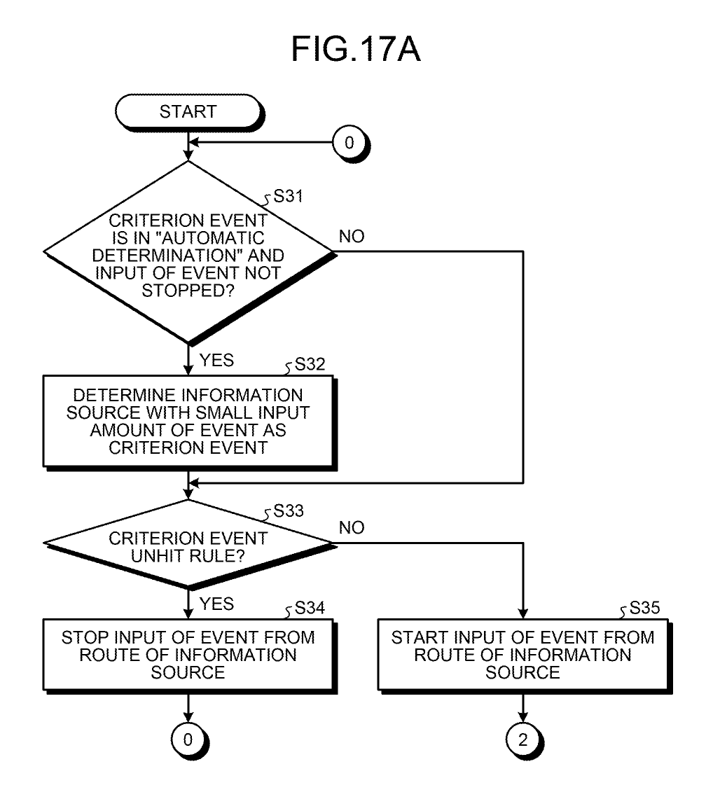

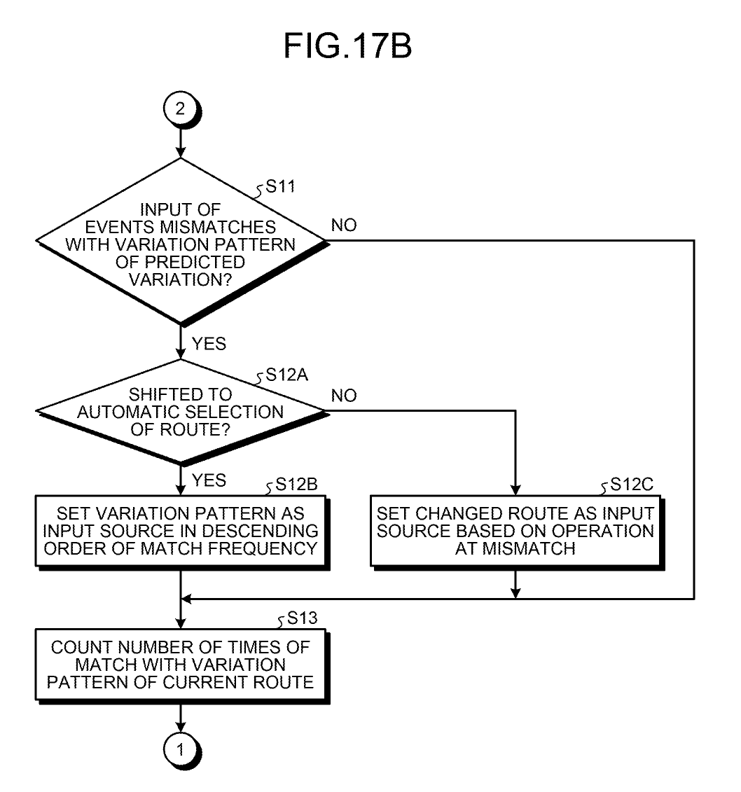

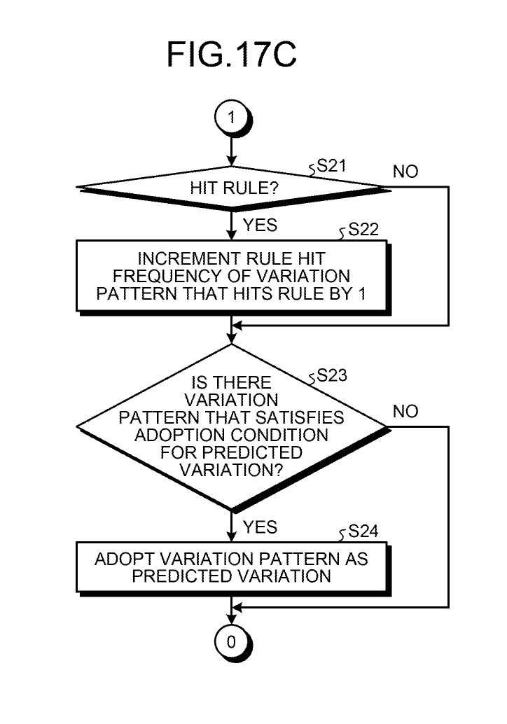

Next, a procedure of the load reduction processing is explained referring to FIGS. 17A to 17C. FIGS. 17A to 17C are flowcharts of the load reduction processing according to the fourth embodiment. In the mismatch operation table 133, the route A is set as the default route 133a, and to change the input source from the route A to the route B is set as the operation at mismatch 133b. In the variation pattern table 200, a variation pattern of a predicted variation is set. Moreover, in the variation pattern table 200, another variation pattern is set, and it is set as “rule hit frequency is 25 hits or more, and is equal to or more than the hit frequency of a predicted variation”. The input unit 141 receives input of events from the input source of the route A that is set as the default route 133a. Furthermore, in the criterion event data 135, “weather forecast” is set as the criterion event. Moreover, because processing from S11 to S24 are the same as that of the load reduction processing according to the third embodiment, explanation of the processing is made brief.

First, the criterion-event determining unit 147 judges whether both conditions are satisfied that the criterion event is in “automatic determination” and that input of any event is not stopped (inhibited) (step S31). When it is judged that the criterion event is not in “automatic determination”, or that input of any event is stopped (step S31: NO), the criterion-event determining unit 147 shifts to step S33.

On the other hand, when it is judged that the criterion event is in “automatic determination” and input of any event is not stopped (inhibited) (step S31: YES), the criterion-event determining unit 147 determines the criterion event to an information source the input amount of events of which is the smallest (step S32). The criterion-event determining unit 147 then sets the determined criterion event in the criterion event data 135. Subsequently, the criterion-event determining unit 147 shifts to step S33.

The event-input inhibiting unit 148 judges whether the criterion event unhits the rule (step S33). When judging that the criterion event unhits the rule (step S33: YES), the event-input inhibiting unit 148 stops input of events from a route of the information source (step S34). For example, as for events that are input from the route A, the event-input inhibiting unit 148 stops input of other events that are different from the criterion event. The event-input inhibiting unit 148 then shifts to step S31 without judging a route change.

On the other hand, when it is determined that the criterion event hits the rule (step S33: NO), the event-input inhibiting unit 148 starts input of events from a route of an information source (step S35). For example, as for events that are input from the route A, the event-input inhibiting unit 148 starts input of other events that are different from the criterion event. The event-input inhibiting unit 148 then shifts to step S11 to judge a route change.

Subsequently, the input unit 141 inputs events from the input source of the route A that is set as the default route 133a. The first judging unit 142 then makes judgment about input of events whether it mismatches with the variation pattern of the predicted variation (step S11).

When judgment as not mismatched with, that is, matched with, the variation pattern of the predicted variation is made about the input of events (step S11: NO), the first judging unit 142 shifts to step S13 to count the number of times of matches.

On the other hand, when judgment as mismatched with the variation pattern of the predicted variation is made about the input of events (step S11: YES), the changing unit 143A judges whether it has shifted to automatic selection of a route (step S12A). When judged that it has not shifted to the automatic selection (step S12A: NO), the changing unit 143A sets a route to which it is changed, to the input source based on the operation at mismatch 133b (step S12C). The load reduction processing then shifts to step S13. Thereafter, the input unit 141 receives input of events from the route B that is the input source after the change.

On the other hand, when judged that it has shifted to the automatic selection (step S12A: YES), the changing unit 143A sets a route as the input source in descending order of the match frequency of the variation pattern (step S12B). The changing unit 143A then changes the input source from the route A that is the current default route to the determined route. The load reduction processing then shifts to step S13. Thereafter, the input unit 141 receives input of events from the route B that is the input source after the change.

At step S13, the pattern-match frequency counter 144 counts the number of times of match with a variation pattern of the current route (step S13).

Subsequently, the rule-hit frequency counter 146 judges whether it hits (conforms to) the rule (step S21). When judging that it hits the rule (step S21: YES), the rule-hit frequency counter 146 increments the rule hit frequency 200c of the variation pattern that his the rule by 1 (step S22). The rule-hit frequency counter 146 then shifts to step S23.

On the other hand, when judging that it does not hit the rule (step S21: NO), the rule-hit frequency counter 146 shifts to step S23.

The rule-hit frequency counter 146 then judges whether there is a variation pattern that satisfies the adoption condition for predicted variation 200d (step S23). When judging that there is a variation pattern that satisfies the adoption condition for predicted variation 200d (step S23: YES), the rule-hit frequency counter 146 adopts the variation pattern as predicted variation (step S24). The load reduction processing then shifts to step S31.

When judging that there is no variation pattern that satisfies the adoption condition for predicted variation 200d (step S23: NO), the rule-hit frequency counter 146 has no processing to perform. The load reduction processing then shifts to step S31.

### Effect of Fourth Embodiment

According to the fourth embodiment described above, the information processing apparatus 1 receives input of events relating to a rule from an input source of the event source. The information processing apparatus 1 inhibits input of other events when the criterion event that is one of events does not conform to the rule. According to such a configuration, the information processing apparatus 1 inhibits input of other events at a point when it is found that the criterion event does not conform to the rule, and therefore, a load of a complex event processing can be further reduced.

Program and the Like

In the embodiments described above, a case in which the CEP system 9 is used for prediction of a traffic jam of vehicles has been explained. However, the CEP system 9 is not limited thereto, and may be used for another purpose. For example, the CEP system 9 may be used for service provision of a rental discount coupon. In such a case, suppose a rule of the CEP system 9 is that “products ‘a’ and ‘b’ are bought at a convenience store, and a rental store is during a rental discount campaign”, and provided information is a “rental coupon at the rental store”. The input unit 141 receives input of events relating to the rule that is used to provide predetermine information, from an input source of an event source. When the default route is an area A, the input unit 141 may receive input of events of purchase information from convenience stores in the area A, and events of information of a rental discount campaign from the rental store. The first judging unit 142 judges whether the input amount of events that are input within a predetermined time period matches with a variation pattern of a predicted variation. When the first judging unit 142 judges that it does not match with the variation pattern of the predicted variation, the changing unit 143 changes the input source from the event source of events that are currently being input, to another event source based on the operation at mismatch 133b. Suppose the operation at mismatch 133b is “to change from the area A to the area B” in this example. The changing unit 143 may change the input source from the area A to the area B based on the operation at mismatch 133b, when the input amount of events of purchase information from convenience stores in the area A does not match with the variation pattern. Moreover, an event of the information of the rental discount campaign may be set as criterion event information. In such a case also, the CEP system 9 can avoid input of events from all of input sources, and a load of a complex event processing can be reduced.

Furthermore, the information processing apparatus 1 can be implemented by installing various functions such as the control unit 14 and the storage unit 13 described above in an information processing apparatus such as a known personal computer and a workstation.

Moreover, each of the components of the apparatus illustrated in the drawings does not always need to be configured physically as illustrated. That is, a specific mode of distribution and integration of the apparatus is not limited to ones illustrated, and a whole or a part thereof may be configured to be distributed/integrated functionally or physically in an arbitrary unit according to various kinds of loads and use conditions. For example, the first judging unit 142 and the second judging unit 145 may be integrated as a single unit of a judging unit. On the other hand, the changing unit 143A may be distributed to a first changing unit that changes an input source based on the operation at mismatch 133b, and a second changing unit that changes an input source based on match frequency. Furthermore, the rule table 131, the variation pattern table 132, and the like may be connected through a network as an external device outside the information processing apparatus 1.

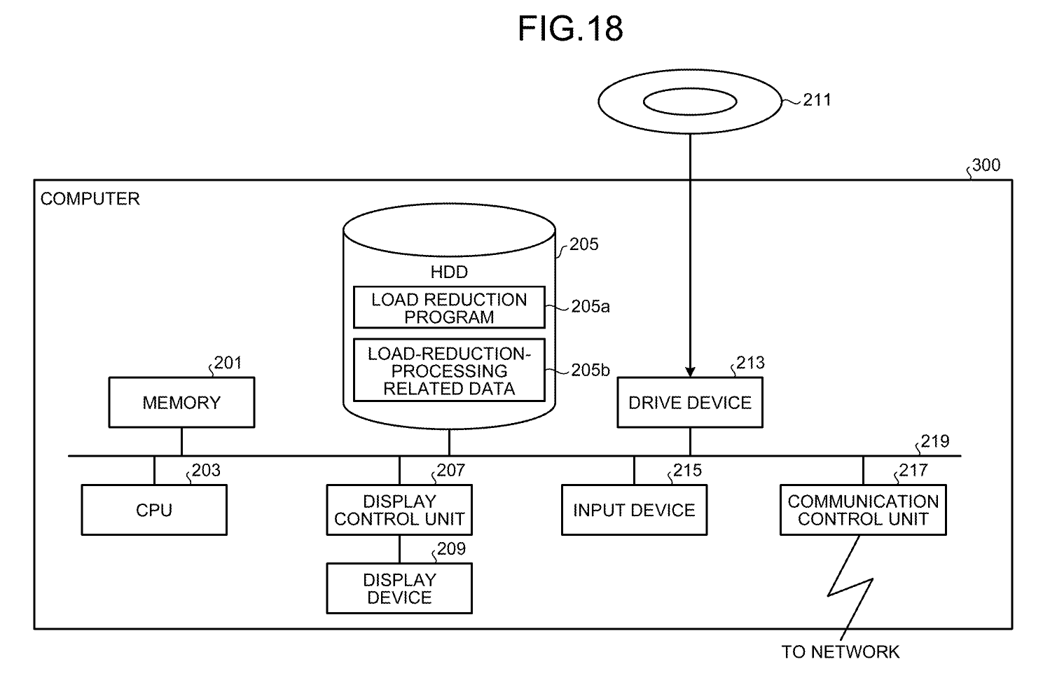

Moreover, the various kinds of processing explained in the above embodiments can be implemented by executing a program prepared in advance by a computer such as a personal computer and a workstation. In the following, an example of a computer that executes load reduction program that implements functions similar to those of the information processing apparatus 1 illustrated in FIGS. 1, 7, 11, and 15 is explained. FIG. 18 is a block diagram illustrating one example of a computer that executes the load reduction program.

As illustrated in FIG. 18, a computer 300 includes a CPU 203, an input device 215 that accepts input of data from a user, and a display control unit 207 that controls a display device 209. Furthermore, the computer 200 includes a drive device 213 that reads a program and the like from a storage medium, and a communication control unit 217 that communicates data with other computers through a network. Moreover, the computer 300 includes a memory 201 and a hard disk drive (HDD) 205 that temporarily stores various kinds of information. The memory 201, the CPU 203, the HDD 205, the display control unit 207, the drive device 213, the input device 215, and the communication control unit 217 are connected through a bus 219.

The drive device 213 is a device for a removable disk 211, for example. The HDD 205 stores a load reduction program 205a and load-reduction-processing related data 205b.

The CPU 203 reads the load reduction program 205a and develops on the memory 201 to execute as a process. The process corresponds to each of the function units in the information processing apparatus 1. The load-reduction-processing related data 205b corresponds to the rule table 131, the variation pattern table 132, the mismatch operation table 133, the pattern-match frequency table 134, and the criterion event data 135. For example, the removable disk 211 stores various data such as the load reduction program 205a.

The load reduction program 205a is not needed to be stored in the HDD 205 from the beginning. For example, the program is stored in a “transportable physical medium” such as a flexible disk (FD), a compact-disc read-only memory (CD-ROM), a digital versatile disk (DVD), a magneto-optical disk, and an integrated circuit (IC) card. The load reduction program 205a may be read from these media by the computer 300 to be executed.

According to one mode of the load reduction program disclosed in the present application, a load of a complex event processing can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a load reduction program that causes a computer to execute a process comprising:
receiving input of events relating to a rule that is used to provide predetermined information, from an input source of an event source;
judging whether there is a variation that is predicted to conform to the rule in an input amount per unit time of events that are input within a predetermined period; and
changing the input source, when judged that there is no variation, from an event source of events that are currently being input, to another event source.

2. The non-transitory computer-readable recording medium according to claim 1, wherein
the judging includes judging whether the input amount matches with a predicted variation that indicates that the input amount per unit time of events that are input within the predetermined period exceeds a predetermined threshold, and
the changing includes changing, when judged as not matched, the input source from the event source of events that are currently being input, to another event source.

3. The non-transitory computer-readable recording medium according to claim 2, wherein the process further comprises
counting a frequency of the variation within a predetermined period for each of a plurality of event sources,
the changing includes determining, when the input source is changed, an event source to which the input source is changed sequentially from an event source that corresponds to a large value of the counted number of times to an event source that corresponds to a small value, and changing the input source from the event source of events that are currently being input, to the determined event source.

4. The non-transitory computer-readable recording medium according to claim 2, wherein the process further comprises
judging, when judged as not matched with the predicted variation, whether the input amount matches with a variation pattern in which the threshold of the predicted variation is changed;
incrementing, when judged as matched with the variation pattern and conforming to the rule, the frequency that corresponds to the variation pattern by 1; and
setting, when the frequency satisfies a predetermined condition, the variation pattern as the predicted variation.

5. The non-transitory computer-readable recording medium according to claim 1, wherein
the receiving includes receiving input of a plurality of events relating to the rule from an input source, and
the process further comprises
inhibiting, when a criterion event that is one of the events does not conform to the rule, input of other events.

6. An information processing apparatus comprising:
a processor; and
a memory, wherein the processor executes:
receiving input of events relating to a rule that is used to provide predetermined information from an input source of an event source;
judging whether there is a variation that is predicted to conform to the rule in an input amount per unit time of events that are input within a predetermined period; and
changing the input source, when judged that there is no variation, from an event source of events that are currently being input, to another event source.

7. A load reduction method performed by a computer, the method comprising:
receiving input of events relating to a rule that is used to provide predetermined information, from an input source of an event source using a processor;
judging whether there is a variation that is predicted to conform to the rule in an input amount per unit time of events that are input within a predetermined period using the processor; and
changing the input source, when judged that there is no variation, from an event source of events that are currently being input, to another event source using the processor.
